(19) United States
(12) Patent Application Publication
(10) Pub. No.: US 2014/0069550 A1
(43) Pub. Date: Mar. 13, 2014

(54) Device and Method of Pumping Fuel Into Vehicle Fuel Tank Without Handle

(71) Applicant: Peter Stiler, Rye Brook, NY (US)

(72) Inventor: Peter Stiler, Rye Brook, NY (US)

(21) Appl. No.: 13/606,806

(22) Filed: Sep. 7, 2012

(51) Int. Cl. F16K 51/00; B65B 3/04

(52) U.S. Cl. 141/1; 251/90

(57) ABSTRACT

A device for pumping fuel in a vehicle fuel tank has an element insertable into a handle of a fuel supplying hose and configured to be located between an activated lever and a wall of the handle so as to retain the lever in an activated position, and the element has a body which is freely insertable into a space between the lever and the wall of the handle and is freely completely removable by a user from the space between the lever and the wall of the handle.

### BACKGROUND OF THE INVENTION

The present invention relates to devices and methods for pumping fuel in a vehicle fuel tank without holding a handle of a fuel supplying hose.

Devices and methods of the above mentioned type are known in the art in the gas supply industry. In the gas supply industry a handle of a fuel supplying hose is provided with a lever which, when pulled up by a user, opens the flow of fuel from the fuel supplying hose and the fuel outlet nozzle insertable into an opening of a fuel tank of a vehicle. In order to release a user's hand from the task of holding the pulled up handle, a tumable piece is turned and presses against the pulled up lever to hold it in its upright position. However, in many instances the tumable piece is not reliable retained in its turned position and thereby is unable to securely maintain the lever in its upright position, resulting in the lever returning to its lower position and interrupting the flow of fuel through the fuel supplying pipe to the fuel outlet nozzle and into the fuel tank. It is therefore believed that it is advisable to develop a device and a method of this type, which can provide a reliable, uninterrupted pumping of vehicle fuel into a fuel tank.

### SUMMARY OF THE INVENTION

Accordingly, it is the purpose of the present invention to provide a device and a method for pumping fuel in a vehicle fuel tank without holding the handle of a fuel supplying hose which is a further improvement on existing devices and methods of this type.

In furtherance of the improvement of existing devices of this type, specifically for pumping fuel in the fuel tank, the device which is the subject of this patent application has an element insertable into a handle of a fuel supplying hose and is configured to be located between an activated lever and a wall of the handle so as to retain the lever in an activated position. The element in question is freely insertable into the space between the lever and the wall of the handle and is freely completely removable by a user from the space between the lever and the wall of the handle.

In accordance with another feature of the present invention, the body of the element has a roughened surface cooperatable with a member selected from the group consisting of the lever of the handle, the wall of the handle, and both, so as to secure the position of the body of the element inside the space and to prevent an accidental slippage of the element from the space between the lever and the wall of the handle during pumping of the vehicle fuel.

In accordance with still a further feature of the present invention, the device is provided with means for connecting the element to a vehicle ignition key, so that the element is connected to the vehicle ignition key at all times permitting the element to be inserted into the space between the lever and the wall of the handle only when the ignition key turns off vehicle ignition and is removed from a vehicle ignition key hole. Therefore the pumping of the vehicle fuel can be carried out only when a vehicle engine is turned off.

In accordance with still a further feature of the present invention, a method of allowing pumping of a vehicle fuel into a vehicle fuel tank is proposed, which includes the steps of introducing a fuel supplying hose into a fuel tank inlet, activating a lever of a handle of the fuel supplying hose, and inserting between the activated lever and a wall of the handle an element to be located between the activated lever and the wall of the handle so as to retain the lever in an activated position, including freely inserting of a body of the element by a user into a space between the lever and the wall of the handle and freely completely removing the body of the element from the space between the lever and the wall of the handle after finishing a process of pumping the vehicle fuel into the vehicle tank.

When the above mentioned device is designed in accordance with the present invention and the method is performed in accordance with the present invention, the lever of the handle of the fuel supplying hose is reliable held in its activated, upright position, the user's hands are free, and the process of pumping a fuel into a vehicle tank is carried out uninterruptedly for the necessary period of time.

The novel features of the present invention are set forth in particular in the appended claims. The invention itself, however, both as to its construction and method of operation, will be best understood from the following description of the preferred embodiments, which is accompanied by the following drawings.

### BRIEF DESCRIPTION OF THE DRAWINGS

FIG. 1 of the drawing is a view schematically showing an element of a device of the present invention, introduced into a handle of a fuel supplying hose during pumping of a fuel into a vehicle tank;

FIG. 2 is a perspective view of the element of the inventive device, showing at least two sides of the element provided with roughening formations; and

FIG. 3 is a view showing one side of the element of the inventive device, provided with the roughening formations.

### DESCRIPTION OF THE PREFERRED EMBODIMENTS

A device for pumping fuel into a vehicle fuel tank in accordance with the present invention is identified as a whole with reference numeral 1. The device 1 is used during pumping of the fuel, when an outlet pipe 2 provided on a handle 3 of a fuel supplying hose 4 is introduced into an opening of a not shown fuel tank of a vehicle.

As well known in the gas supply industry, the opposite end of the fuel supplying hose operates in conjunction with a not shown fuel storage, as for example in a fuel supply station. When a lever 5 provided in the handle 3 is activated, as for example when lifted to its upright position, the fuel communication is established, and the fuel flows freely into the vehicle tank.

The inventive device includes an element 6 freely insertable into the handle 3 by a user and freely removable from the handle 3 by the user. In other word, the element 3 has no fixed and/or permanent connections to the handle.

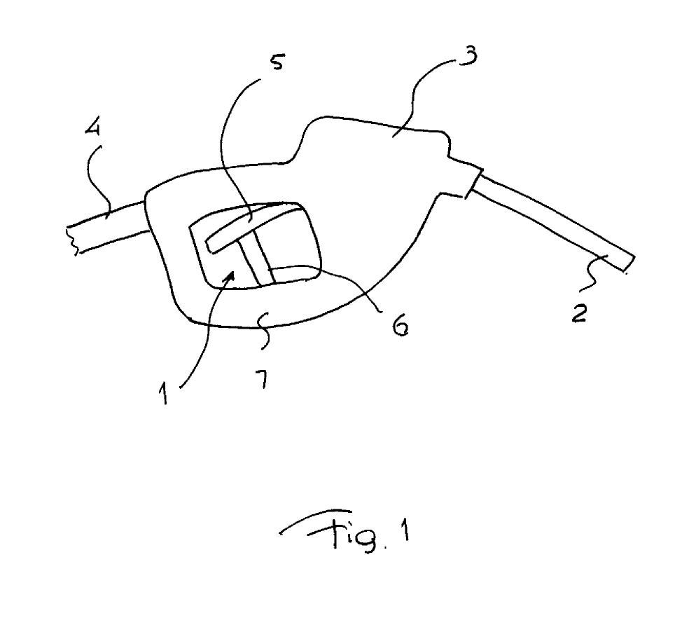

As shown in particular in FIG. 1, when the lever 5 of the handle is activated or in other words lifted by a user, the user introduces the element 6 into a space between the activated or lifted up lever 5 of the handle and an opposite wall 7 of the handle. With a body of the element 3 located between the lifted lever 5 and the wall 7 of the handle 3, the lever 5 is secured in its upright position, and therefore a communication between the fuel supplying hose 4 and the outlet pipe 2 is continuously and uninterruptedly maintained, and the fuel flows into the vehicle fuel tank.

After filling the fuel tank of the vehicle, the user completely removes the element 6 from the space between the lever 5 and the wall 7 of the handle, and the lever 5, in a known manner, moves back, for example under the action of a spring, to its original non-activated position. The process of supplying fuel into a vehicle fuel tank thereby stops.

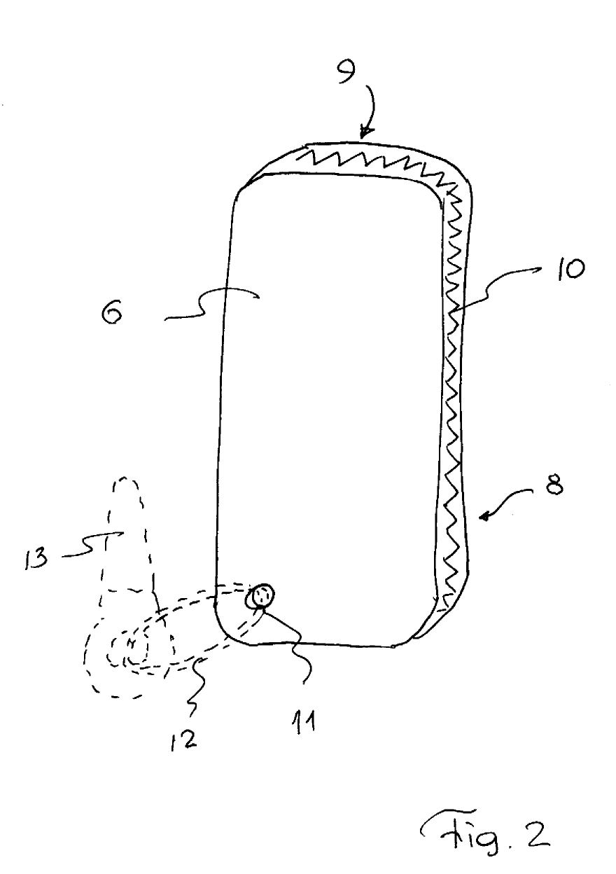

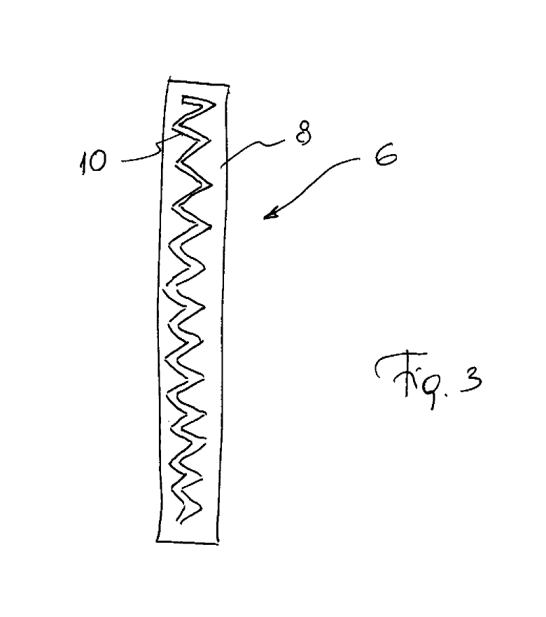

As shown for example in FIGS. 2 and 3, one or more side surfaces 8 and 9 can be provided with roughening formations 10. They can be formed for example by a plurality of small peaks or projections formed on these surfaces, by a plurality of ribs formed between a plurality of depressions on these surfaces , by a plurality of zig-zag elevations on these surfaces, etc.

The roughening formations 10 provide an increased friction between the body of the element 6 on the one hand, and the lever 5 of the handle, or the wall 7 of the handle, or both the lever 5 and the wall 7 of the handle 3 on the other hand. It thereby increases reliability of retention of the element 6 inside the space between the lever 5 and the wall 7 of the handle 3, when the element 6 is inserted into the space, and the element 6 can not accidentally slide out of the handle.

In accordance with another feature of the present invention, the element 6 can be provided with means for connection to an ignition key of the vehicle as shown in FIG. 2. This means can be formed for example as a hole 11 in the body of the element 6, and can also include a ring 12 extending through the hole 11. An ignition key 13 of the vehicle can be connected to another portion of the ring 12. This provides an advantageous and efficient result.

It is well known that it is strongly recommended to turn off the vehicle engine before pumping a fuel into a fuel tank. This requirement is forcefully enforced when the above mentioned feature is provided in the present invention. In order to introduce the element 6 of the inventive device into the handle 3 and pump the fuel, it is absolutely necessary to remove the ignition key 13 from the ignition key hole resulting in the shutting down of the vehicle engine. Only thereafter can the element 6 can be inserted into the handle 3 and operate as described hereinabove.

The invention is not limited to the details shown since various modifications and structural changes are possible without departing from the spirit of the invention.

What is desired to be protected by Letters Patent is set forth in the appended claims.

1. A device for pumping fuel in a vehicle fuel tank, comprising an element insertable into a handle of a fuel supplying hose and configured to be located between an activated lever and a wall of the handle so as to retain the lever in an activated position, wherein said element has a body which is freely insertable into a space between the lever and the wall of the handle and is freely completely removable by a user from the space between the lever and the wall of the handle.

2. A device as defined in claim 1, wherein said body of said element has a roughened surface cooperatable with a member selected from the group consisting of the lever of the handle, the wall of the handle, and both, so as to secure a position of said body of said element inside the space and to prevent an accidental slippage of said element from the space between the lever and the wall of the handle during pumping of the vehicle fuel.

3. A device as defined in claim 1, further comprising means for connecting said element to a vehicle ignition key, so that said element is connected to the vehicle ignition key at all times and thereby said element is insertable into the space between the lever and the wall of the handle only when the ignition key turns off vehicle ignition and is removed from a vehicle ignition key hole and thereby pumping of the vehicle fuel can be carried out only when a vehicle engine is turned off.

4. A method of allowing pumping of a vehicle fuel into a vehicle fuel tank, comprising the steps of introducing a fuel supplying hose into a fuel tank inlet; activating a lever of a handle of the fuel supplying hose, and inserting between the activated lever and a wall of the handle an element to be located between the activated lever and the wall of the handle so as to retain the lever in an activated position, including freely inserting of a body of the element by a user into a space between the lever and the wall of the handle and freely completely removing the body of the element from the space between the lever and the wall of the handle after finishing a process of pumping the vehicle fuel into the vehicle tank.
